(19) United States
(12) Patent Application Publication
(10) Pub. No.: US 2003/0185160 A1
(43) Pub. Date: Oct. 2, 2003

(54) Technique for use in an echo canceller for providing enhanced voice performance for mobile-to-mobile calls in a GSM environment through use of inter-canceller communication and co-ordination

(75) Inventor: Ronald H. Tegethoff, Tinton Falls, NJ (US)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: NMS Communications Corporation

(21) Appl. No.: 10/400,392

(22) Filed: Mar. 27, 2003

Related U.S. Application Data
(60) Provisional application No. 60/368,693, filed on Mar. 29, 2002.

(51) Int. Cl. H04B 3/20

(52) U.S. Cl. 370/286; 370/289

(57) ABSTRACT

Apparatus for an echo canceller, and an accompanying method for use therein, for improving voice performance in handling mobile-to-mobile calls in a GSM environment, specifically with a base station controller (BSC) at each end of a call path where one BSC supports tandem free operation (TFO) and the other does not. Here, each canceller has a capability, through unique in-band messaging carried by robbed-bit signaling, to communicate information with its peer (distant) echo canceller across the call path so as to permit each canceller to coordinate its operation with the other, and particularly to enable a specific voice enhancement feature set optimal to a particular type of call, e.g., mobile-to-mobile, and without adversely affecting the TFO protocol.

### CLAIM TO PRIORITY

This application claims priority of my co-pending U.S. provisional patent application entitled “PROPOSAL FOR IMPROVING ECHO CANCELLER PERFORMANCE ON MOBILE-TO-MOBILE CALLS” filed Mar. 29, 2002, accorded serial No. 60/368,693 and which is incorporated by reference herein.

### BACKGROUND OF THE DISCLOSURE

1. Field of the Invention

The invention relates to a technique, specifically apparatus and an accompanying method, for use in an echo canceller for improving voice performance in handling mobile-to-mobile calls in a global system for mobile communications (GSM) environment, specifically with a base station controller (BSC) at each end of a call path where one BSC supports tandem free operation (TFO) and the other does not. Here, each canceller has a capability, through unique in-band messaging carried by robbed-bit signaling, to communicate information with its peer (distant) echo canceller across the call path so as to permit each canceller to coordinate its operation with the other, and particularly to enable a specific voice enhancement feature set optimal to a particular type of call, e.g., mobile-to-mobile, but without adversely affecting the TFO protocol.

2. Description of the Prior Art

Particularly in the past decade or so, mobile (particularly cellular), as contrasted with traditional wireline, telephony has experienced considerable growth. At its essence, cellular technology relies on dividing a geographic territory into predefined cells. Each cell contains a base station. Each cellular user employs a handset, i.e., which is a radio-telephone transceiver that transmits and receives a digitized telephone call, typically carried using time division multiple access (TDMA), in relatively new systems, code division multiple access (CDMA) and in Europe, GSM. The base station has a base station controller (BSC) and communicates with and co-ordinates operation of all cellular handsets within its associated cell. A number of base station controllers are themselves connected to a mobile switching center which switches mobile calls between separate base stations as well as to and from a public switched telephone network (PSTN).

A continuing goal in the telecommunications industry has been to make mobile-to-mobile calls “sound” as good as mobile-to-wireline calls.

Regardless of the whether a call is either mobile or wireline, that call will experience some degree of echo and for that reason the audio signal appearing on each path of the call is processed through an echo canceller to cancel and drastically reduce, if not totally eliminate, the echo.

Conventional echo cancellers are designed to impart a variety of voice (audio) enhancement features to a call, including: adaptive filtering (AF), i.e., echo cancellation; non-linear processing (NLP), automatic volume control (AVC), noise compensation (NC), noise reduction (NR) and acoustic echo control (AEC). In a conventional CDMA/TDMA environment as occurs in North America, echo cancellers are situated in so-called “loop-around” trunks in the MSC, with one canceller for each end of the call. It is widely known that if a mobile-to-mobile call is established through an MSC and the call is routed through two echo cancellers, each of which imparts its full panoply of voice enhancement features to the call, the voice quality of the call will actually degrade. The reason for this is simply that some of the features prove to be unnecessary. In particular, in a CDMA to CDMA call, the only features that are beneficial are AEC, one AVC in each direction, NR and possibly NC. Degradation occurs when two separate instances of each adaptive filtering and non-linear processing, and an additional automatic voice control instance are all active on the same call.

To avoid this degradation in the context of a North American CDMA/TDMA network architecture, all mobile-to-mobile calls were routed over dedicated loop-around trunks having two echo cancellers, with each canceller provisioned with its adaptive filtering and non-linear processing features disabled and the automatic volume control feature on one direction of the cancellers disabled. This left only both acoustic echo control and noise reduction features, across both cancellers, enabled and a single automatic volume control enabled on one direction for each of the cancellers. In contrast, for mobile-to-PSTN (wireline) calls, the echo canceller on a PSTN side of the MSC would be provisioned to impart all its voice enhancement features to the call.

While this approach functioned well in a North American CDMA/TDMA network environment, problems arose with echo cancellers used with GSM-based (European) network architectures.

Rather than positioning echo cancellers in loop-around trunks, or on a PSTN side of the MSC as is the case with a CDMA/TDMA, in a GSM environment, echo cancellers are always situated directly in an “A” link between each BSC and the MSC. Consequently, both mobile-to-mobile and mobile-to-PSTN calls utilize the same echo canceller. In this arrangement, for optimizing voice quality, the echo canceller on a mobile-to-mobile call would only utilize their acoustic echo control and noise reduction features, and only one of the automatic volume control feature in a call path. For a mobile-to-mobile call there would be two echo cancellers provisioned as above in the call path. On a mobile-to-PSTN call, each of the echo cancellers would utilize its adaptive filtering, non-linear processing, noise compensation, noise reduction and automatic volume control features. As such, both mobile and PSTN users would obtain compromised voice performance through the same echo cancellers. However, this situation could be avoided if each echo canceller could be instructed, through some type of signaling protocol, that it is connected to a mobile trunk or to a PSTN wireline trunk so it could set its feature set accordingly. Certain BSCs implement an in-band signaling protocol called “Tandem Free Operation” (TFO). Through this protocol, in-band signaling (IS) messages are sent in two least significant bits (LSBs) of every 16th PCM sample, i.e., via so-called “robbed-bit signaling”. Detection of an IS message indicates when a connection is mobile-to-mobile. Such messages are sent by a BSC to a distant BSC to signal the latter that 8 or 16 kb compressed speech can be directly transferred, in a “clear channel” between BSCs using the two LSBs, without intermediate processing such as any intervening compression/decompression (e.g., via 8-bit μ-law or A-law). The remaining six bits are μ- or A-law encoded and contain all voice processing. This approach provides enhanced quality by eliminating an otherwise additional, but unnecessary, stage of compression and decompression. Therefore, an echo canceller would simply respond to an appropriate incoming IS message and set its feature set to a TFO defined mode where the 2 LSBs bypass any processing and the remaining six bits are still processed for echo cancellation and voice enhancements. However, a large number of BSCs currently in use in Europe are not TFO equipped. Consequently, changing over those BSCs to a version that uses TFO is exceedingly expensive, particularly given the large numbers involved. Hence, from a financial standpoint, changing over BSCs to those which use TFO is rather impractical and thus highly disfavored.

In any event, in GSM-environments where a BSC does implement TFO, a conventional echo canceller capable of only TFO is connected to that BSC would normally be provisioned to continually monitor for in-band signaling request messages (IS_REQ) and (IS_ACK) messages from the BSC. Whenever another TFO capable BSC received the IS_REQ message it would send an IS_ACK message. The IS_REQ and IS_ACK interchange causes both BSCs to enter into a TFO mode. Each of the echo cancellers detects the IS_REQ and IS_ACK messages. Accordingly, each canceller then sets its voice enhancement features to a set which is predefined, and appropriate and optimized for a mobile-to-mobile call. Both echo cancellers allow the two LSBs to pass through the cancellers in a clear channel mode while still processing the remaining six bits in μ- or A-law and providing echo cancellation and all voice enhancements. If an IS_REQ and IS_ACK messages were not both received, the canceller would process all eight bits in μ- or A-law coding and set those features to a set which is appropriate and optimized for a mobile-to-PSTN (wireline) call. For a mobile-to-mobile call, each echo canceller would independently respond to the presence or absence of an IS_REQ message at its Sᵢₙ port and an IS_ACK message at its Rᵢₙ port simultaneously. That canceller, in turn, would then send the IS_REQ message out from its Sₒᵤₜ port and IS_ACK message from its Rₒᵤₜ port. “Voice enhancement optimization (VEO)” is said to occur when the echo canceller is provisioned to provide different degrees of voice enhancement based on the type of call it is handling. Presently only in the TDMA/CDMA loop-around trunk applications can the echo canceller and voice enhancements be optimized for a specific application.

Furthermore, an echo canceller also provides, as another voice enhancement feature, a feature called “dynamic speech restoration (DSR)”. The DSR feature utilizes a finite impulse response filtering algorithm to overcome voice impairments of tandem vocoders without requiring use of a TFO signaling protocol. A conventional echo canceller can only utilize the DSR feature specifically for mobile-to-mobile calls in the CDMA/TDMA loop-around trunk architecture. On mobile-to-PSTN wireline calls DSR will actually degrade the voice quality of the call.

In addition, a problem arises where a call is carried in a GSM environment between two BSCs where one implements TFO and another does not. Specifically, in this network configuration, which routinely occurs, one BSC is sending IS_REQ messages but the other BSC is not sending any TFO message. The result is a call that is not in TFO and hence both cancellers would receive and pass through just an IS_REQ message. Since the non-TFO BSC cannot send an IS_ACK message, the echo canceller and voice enhancements cannot use either the VEO or DSR capabilities to optimize the voice quality to this mobile-to-mobile call. Thus far, no solution exists in the art that would permit VEO and DSR to be utilized on mobile-to-mobile calls and disable this feature for mobile-to-PSTN calls while utilizing the same echo canceller.

Therefore, a need exists in the art, to provide an echo canceller, specifically apparatus and an accompanying method for use therein, for use in a GSM environment and which can properly handle mobile-to-mobile and mobile-to-wireline calls that simultaneously transit through both TFO and non-TFO based BSCs, while preserving the TFO protocol. Such a canceller, by being able to select a feature set (both VEO and DSR) based on call type, would provide enhanced voice quality for mobile-to-mobile calls that compared very favorably to that currently provided for mobile-to-PSTN calls. Advantageously, such a canceller would eliminate any need to change a BSC from a non-TFO type to one that supports TFO, while providing its advantages. Given that a pair of such echo cancellers is typically far less costly than is a BSC, use of such cancellers presents a highly cost-effective approach to providing enhanced voice performance for handling mobile-to-mobile calls in a GSM environment than otherwise.

### SUMMARY OF THE INVENTION

The present invention advantageously satisfies this need by providing an echo canceller that has an ability to communicate call type information, through in-band signaling, to its peer canceller using unique TFO signaling messages, i.e., messages that have meaning only to the peer echo canceller. By virtue of such communication, each canceller can set its enhancement feature set to handle a given call not only to one appropriate to the type of call, i.e., mobile-to-mobile or mobile-to-PSTN, but also appropriate to whether each BSC at each end of the call is TFO equipped or not.

Broadly speaking, my inventive echo canceller has the ability to originate a signaling message for transport over a call path to its peer echo canceller situated at an opposite end of the call path such that the former canceller can communicate and interact with the latter.

In accordance with my specific inventive teachings, each canceller detects incoming TFO messages on its Rᵢₙ and Sᵢₙ lines, or the absence of such messages, and in response thereto generates appropriate TFO messages back to its peer canceller. In those situations where each BSC on either end of a call is not TFO equipped or where one BSC is TFO equipped but the other is not, each canceller would generate a specific unique TFO message (IS_VT) so as to instruct its peer canceller as to the call type.

Advantageously, the IS_VT message, while being sufficiently unique and having a meaning only to the cancellers, is not only compatible with TFO, i.e., capable of being carried by 2-bit robbed-bit signaling, but permits each canceller to uniquely communicate with each other, thereby allowing each to coordinate its operation with the other. In that regard, the IS_VT message is not part of normal TFO messaging and has meaning only with and is only interpreted by each canceller. Hence, through use of unique inter-canceller messaging, a pair of echo cancellers can jointly communicate call type between themselves and coordinate their operation so as to enable particular voice enhancement features in each canceller appropriate to the call and network configuration, thus providing enhanced voice quality than heretofore possible.

Further, by virtue of using such unique messaging, the present invention will seamlessly function to provide enhanced voice quality in those network configurations where a common mobile-to-mobile call is routed through both TFO and non-TFO capable base station controllers (BSCs), without advantageously requiring any change to either of the BSCs.

### BRIEF DESCRIPTION OF THE DRAWINGS

The teachings of the present invention can be readily understood by considering the following detailed description in conjunction with the accompanying drawings, in which:

FIG. 1 depicts basic network configuration 100 for handling mobile-to-mobile telephone calls in a GSM environment;

FIG. 2 depicts network configuration 200, based on that shown in FIG. 1, which employs the inventive echo cancellers, and associated inter-canceller signaling, where a mobile-to-mobile call is being handled but where neither base station controller (BSC) 220_{A} or 220_{B} has tandem free operation (TFO) capability;

FIG. 3 depicts network configuration 300, based on that shown in FIG. 1, which employs the inventive echo cancellers, and associated inter-canceller signaling, where a mobile-to-PSTN call is being handled but where neither BSC 220_{A} or 220_{B} has TFO capability;

FIG. 4 depicts network configuration 400, based on that shown in FIG. 1, which employs the inventive echo cancellers and associated inter-canceller signaling, where a mobile-to-mobile call is being handled, and where both BSCs 420_{A} and 420_{B} have TFO capability;

FIG. 5 depicts network configuration 500, based on that shown in FIG. 1, which employs the inventive echo cancellers, and associated inter-canceller signaling, where a mobile-to-mobile call is being handled but where only one BSC 420_{A} has TFO capability but another such controller 220_{B} does not;

FIG. 6 depicts a two-bit robbed-bit signaling scheme used by the BSCs and the inventive echo canceller to carry TFO in-band signaling (IS) messages;

FIG. 7 depicts a high-level block diagram of message detection/generation (communication) and control sections of inventive echo canceller 700, as shown in each of FIGS. 2-4 as each of cancellers 700_{A} and 700_{B};

FIG. 8 depicts a high-level block diagram, particularly of voice processing sections, of inventive echo canceller 700 also shown in FIG. 7, but specifically depicting voice enhancement and adaptive filtering features provided by the canceller, along with IS message detector and generator functions, and particularly which of those features are enabled within that canceller for handling a mobile-to-mobile call, for network configuration 200 shown in FIG. 2, in response to detection of an incoming IS_VT signal;

FIG. 9 depicts a high-level block diagram, particularly of the voice processing sections, of inventive echo canceller 700 also shown in FIG. 7, but specifically depicting the voice enhancement and adaptive filtering features provided by the canceller, along with IS message detector and generator functions, and particularly which of those features are enabled within that canceller for handling a mobile-to-PSTN call, for network configuration 300 shown in FIG. 3 in the absence of the canceller detecting any incoming IS message; and

FIG. 10 depicts a high-level block diagram, particularly of the voice processing sections, of inventive echo canceller 700 also shown in FIG. 7, but specifically depicting the voice enhancement and adaptive filtering features provided by the canceller, along with IS message detector and generator functions, and particularly which of those features are enabled within that canceller for handling a mobile-to-mobile call, for network configuration 400 shown in FIG. 4 in response to detection of an IS_REQ message.

To facilitate understanding, identical or similar reference numerals have been used, where possible, to designate identical or similar elements, respectively, that are common to the figures.

### DETAILED DESCRIPTION

After considering the following description, those skilled in the art will readily appreciate that the teachings of my present invention can be broadly utilized in implementing communication between one echo canceller and another such that both cancellers can interact with each other during active call processing in order to coordinate their operation so as to improve overall call processing and/or exchange data or other information between themselves; To simplify the ensuing discussion, the inventive echo canceller will be discussed in a specific context of its use within a GSM network environment in order to communicate call type information to its peer (distant) echo canceller, situated across an active call path, in order to improve voice quality of a mobile-to-mobile call particularly in situations where one base station controller (BSC) on one end of the call path is equipped with tandem free operation (TFO) and another BSC at an opposite end of the call path is not.

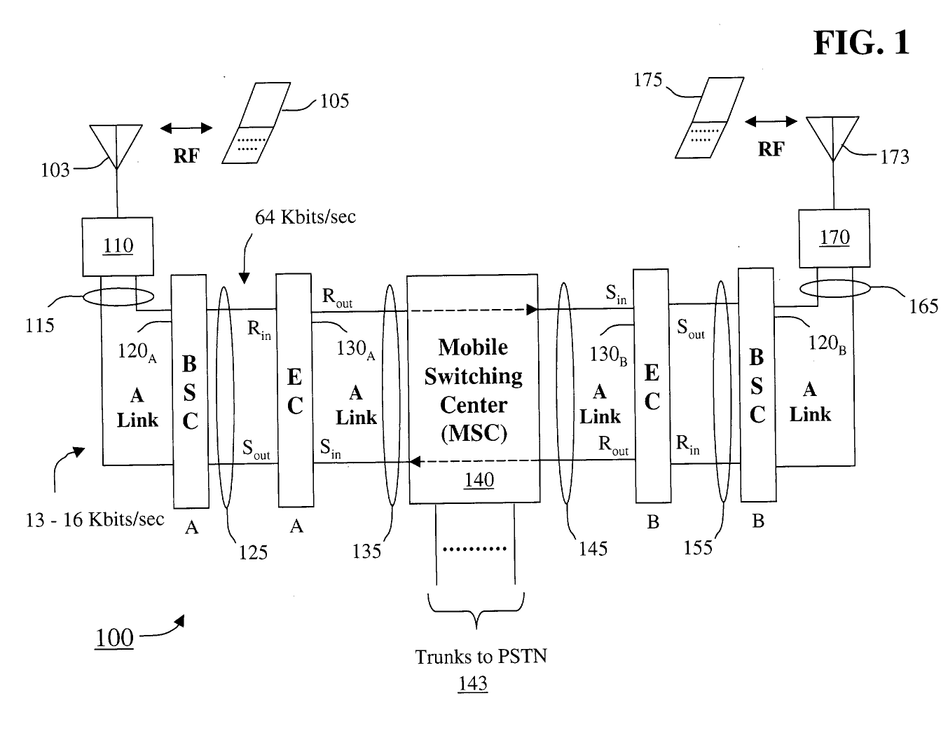

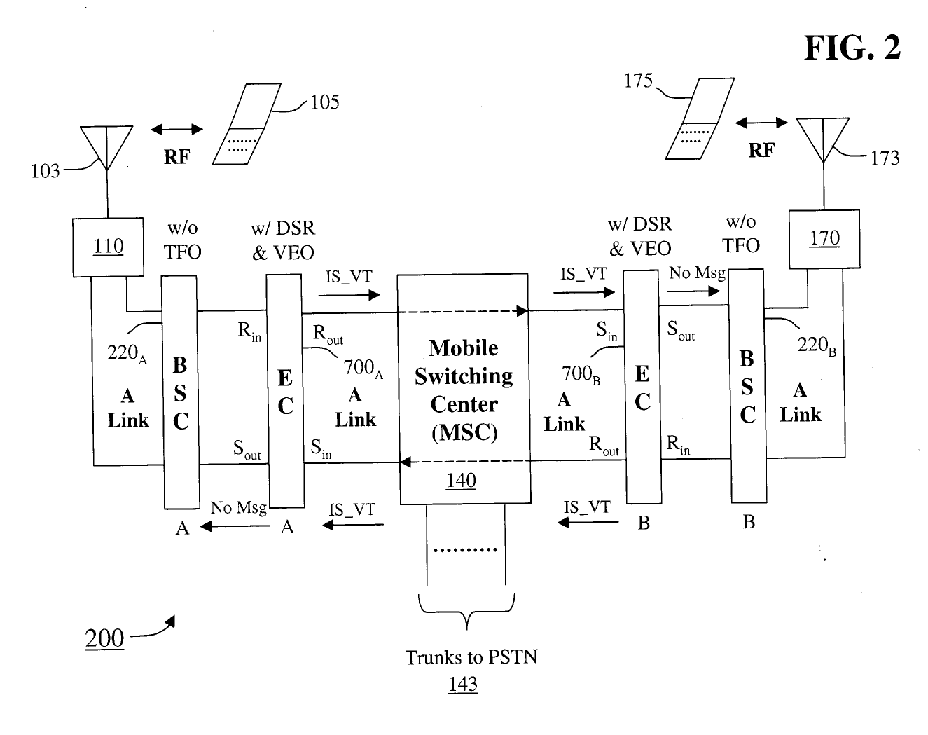

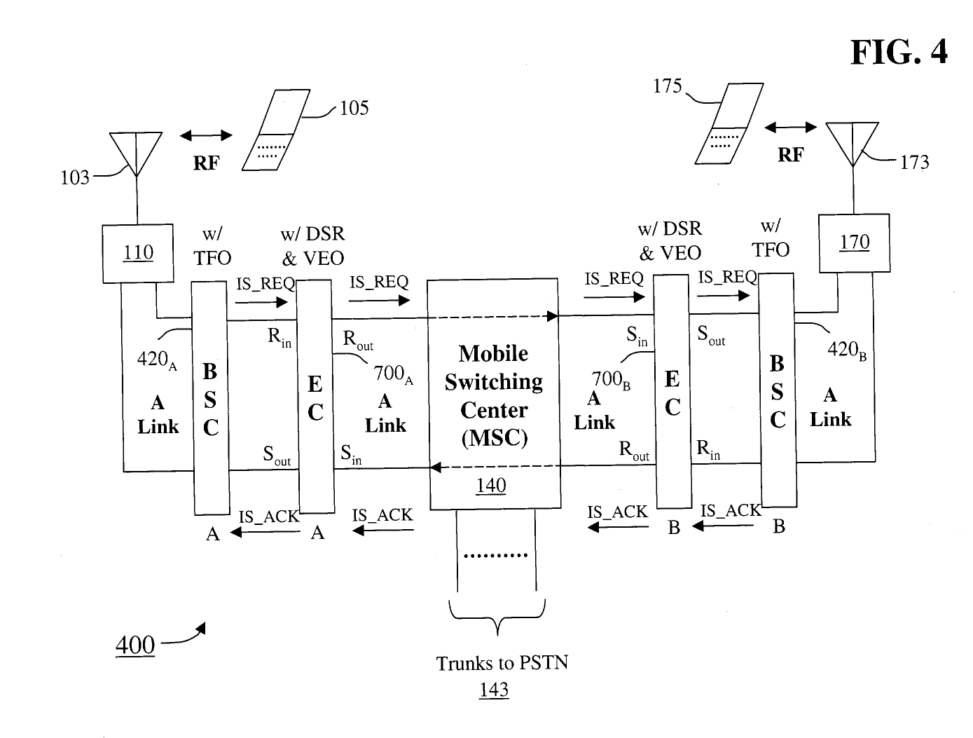

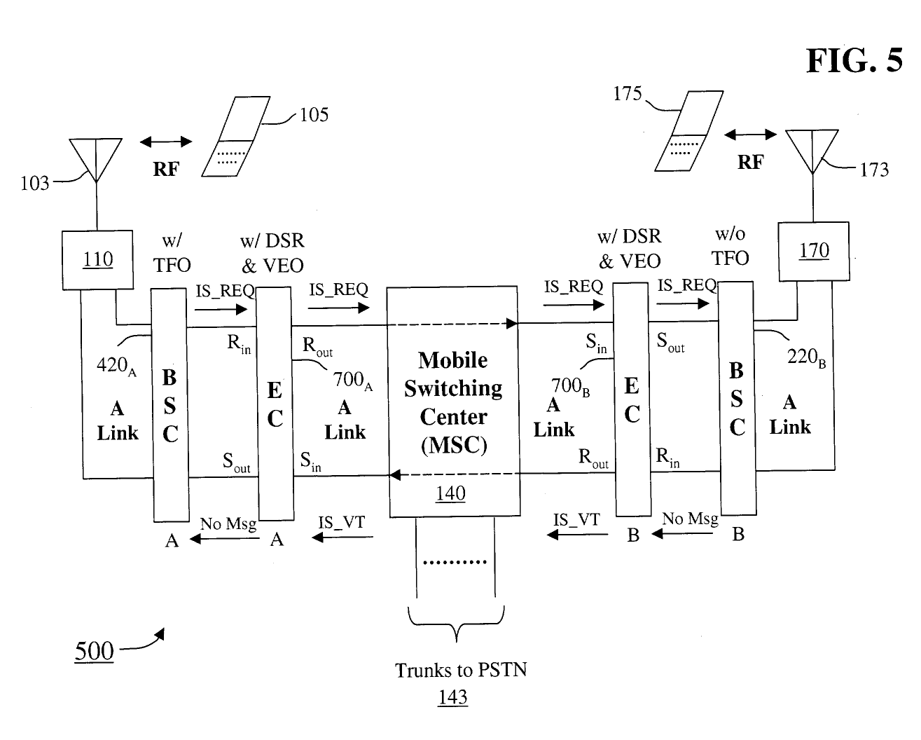

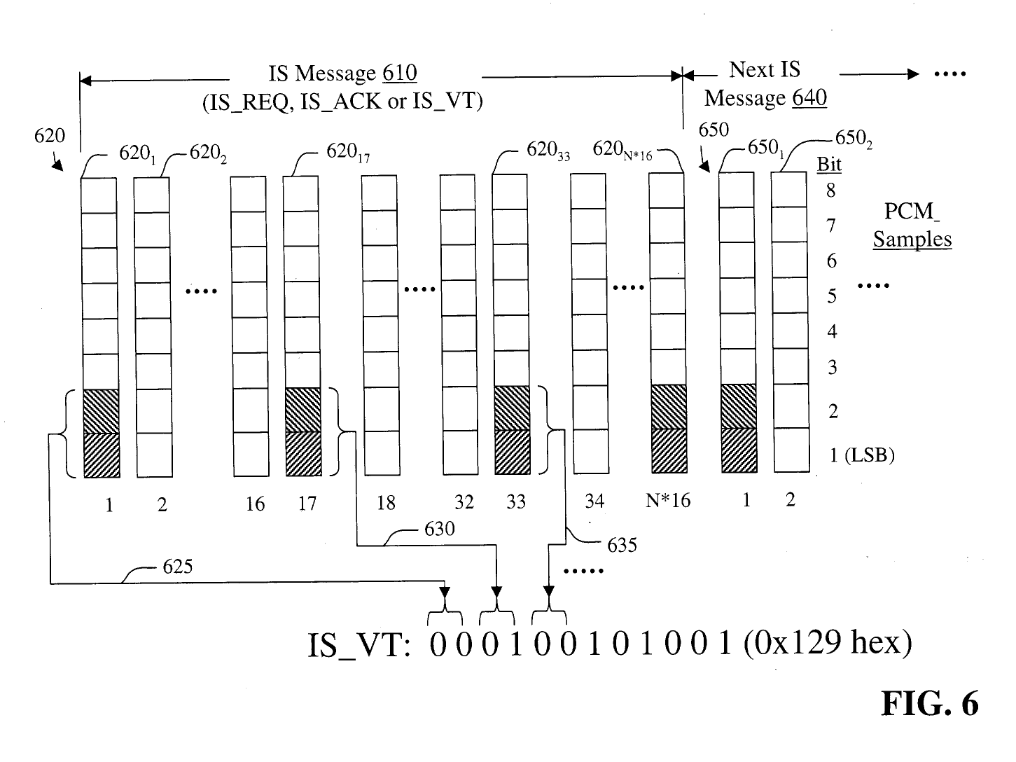

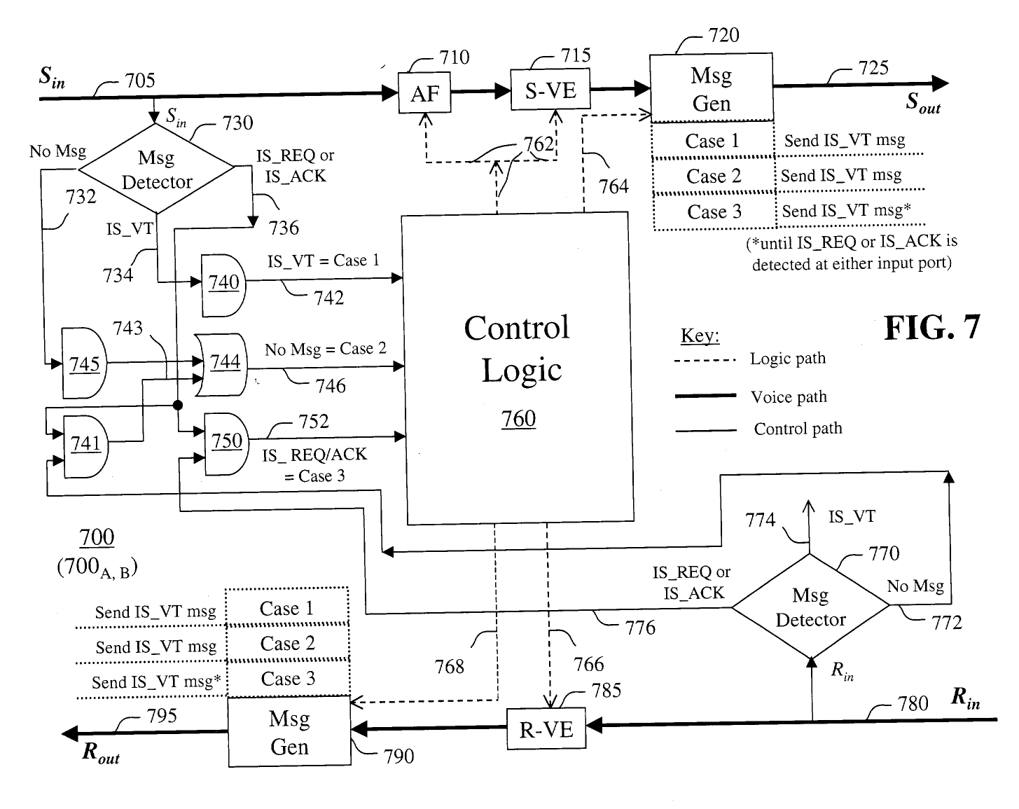

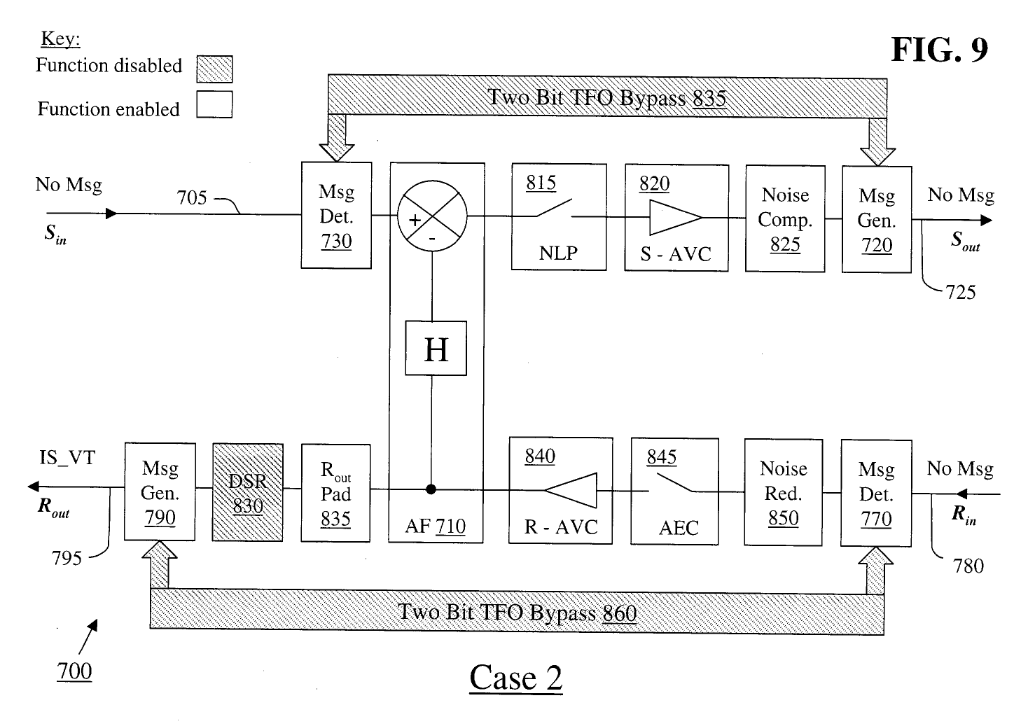

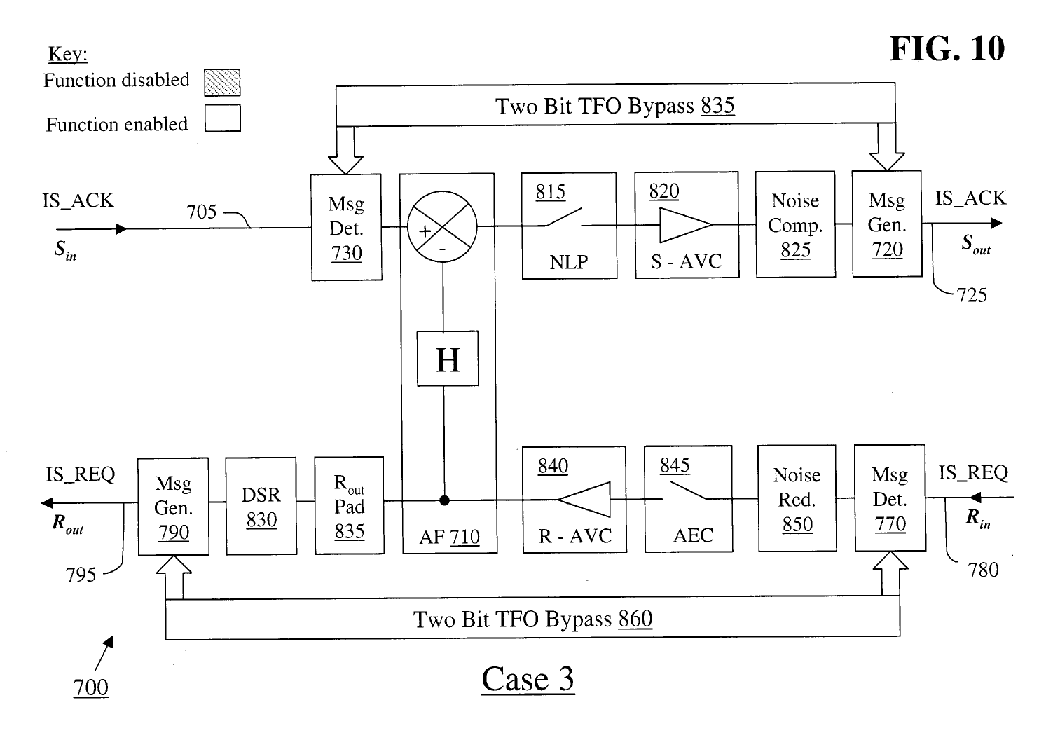

To clearly elucidate the invention, I will proceed as follows. First, I will describe the general GSM network environment for handling mobile-to-mobile and mobile-to-PSTN (wireline) calls (FIG. 1). Thereafter, I will separately discuss operation and associated in-band signaling, which occurs in that environment, including that of the inventive canceller when handling mobile-to-mobile and mobile-to-PSTN calls where, for the mobile party, that end of the call is handled by a BSC that does not have TFO capability (FIGS. 2-3, and 8-9, respectively). Next, I will discuss operation and associated in-band signaling, which occurs in that environment, including that of the inventive canceller, when handling mobile-to-mobile calls where the BSC on each end of the call has TFO capability (FIG. 4 and 10), and where one such BSC has TFO capability but the other does not (FIGS. 5 and 9). Lastly, I will address, in the context of FIG. 6, robbed-bit signaling used by the inventive echo canceller and, in the context of FIG. 7, the constituent high-level functional control and communication blocks that form my inventive echo canceller.

To begin, FIG. 1 depicts basic network configuration 100 for handling mobile-to-mobile telephone calls in a GSM environment. As shown, this configuration includes BSCs 120_{A} and 120_{B} (also referred to as BSC A and BSC B, respectively), echo cancellers (ECs) 130_{A} and 130_{B} (also referred to as EC A and EC B, respectively), mobile switching center (MSC) 140 and mobile-telephony radio equipment 110 and 170 along with antennas 103 and 173, respectively. In particular, mobile handsets 105 and 175 bi-directionally interact through an RF (radio frequency) intermediary, either on a CDMA (code division multiple access) or TDMA (time division multiple access) basis, via antennas 110 and 173 with equipment 110 and 170, respectively. Since specific operation of the radio equipment, including CDMA and TDMA, is irrelevant to the present invention, such aspects will not be discussed in any detail hereinafter. Radio equipment 110 and 170 are correspondingly interfaced through well known “A” links operating at 13-16 Kbits/second/channel with BSCs 120_{A} and 120_{B}.

In a GSM environment as shown, echo cancellers, specifically EC 130_{A} and 130_{B}, are situated directly in series with the BSCs, here BSC 120_{A} and 120_{B}, and particularly in the A links emanating therefrom and terminating at MSC 140. Each A link carries PCM sample data at 64 Kbits/second/channel. Echo cancellers 120_{A} and 120_{B} each provides a set of conventional voice enhancement features collectively referred to as “Voice Enhancement Optimization (VEO)”. These features include adaptive filtering (AF), i.e., echo cancellation; non-linear processing (NLP), automatic volume control (AVC), noise compensation (NC), noise reduction (NR), acoustic echo control (AEC) and dynamic speech restoration (DSR). Depending on whether the call then being handled is a mobile-to-mobile or a mobile-to-PSTN call, certain of these features would be enabled, and others would not. In that regard, in handling a mobile-to-mobile call in this GSM environment, each echo canceller 120_{A} and 120_{B}, situated at opposite ends of the call, would enable its AEC, DSR and NR features, but only one of these cancellers would also invoke its AVC feature. In contrast, in handling a mobile-to-PSTN call, each canceller would enable all its voice enhancement features except DSR. Suffice it to say that using different feature sets in a GSM environment is required by inherent differences in the manner through which voice information on mobile-to-mobile calls and mobile-to-PSTN calls are encoded, thus assuring that the resulting voice quality on mobile-to-mobile calls favorably compares with that for mobile-to-PSTN calls.

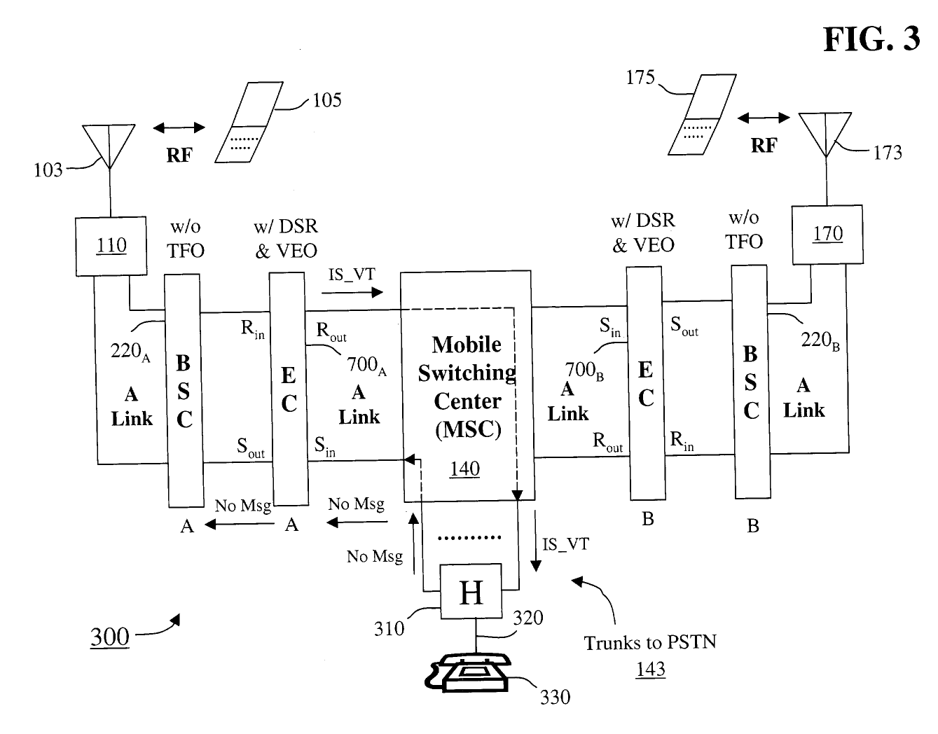

To handle a mobile-to-PSTN call, MSC 140 would connect the appropriate BSC, through its corresponding EC, to one of trunks 143. Dashed lines denote voice paths through the MSC for a mobile-to-mobile call (and similarly in FIGS. 2 and 4; and for a mobile-to-PSTN call in FIG. 3).

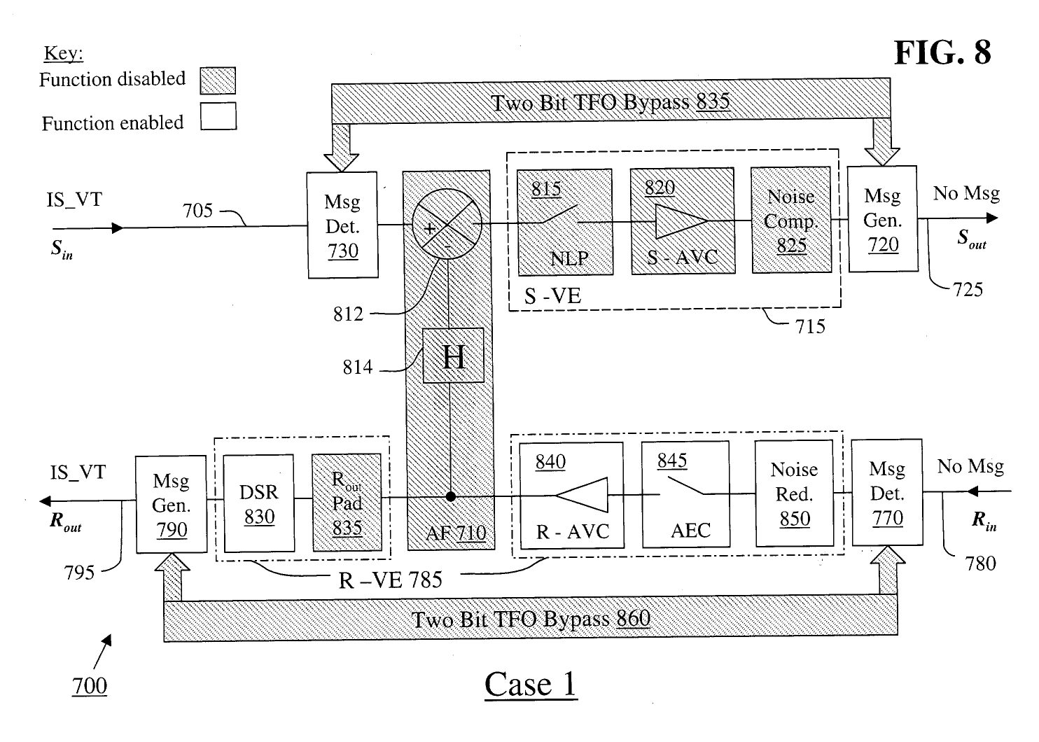

Assuming that neither BSC in GSM network configuration 100 has TFO capability, then a mobile-to-mobile call would be handled through network configuration 200 shown in FIG. 2. Network configuration 200 includes the inventive echo cancellers, as each of cancellers 700_{A} and 700_{B}. A high-level block diagram of the same inventive echo canceller, but with increased detail as to its adaptive filtering and voice enhancement features, is shown in each of FIGS. 8-10. To facilitate understanding, the reader should simultaneously refer to FIGS. 2 and 8 (the latter being the most appropriate figure here within FIGS. 8-10) throughout the following discussion.

As indicated in FIG. 8, receive path voice enhancement (R-VE) features 785 include: DSR 830, Rₒᵤₜ pad 835, R-AVC 840 (since both send and receive paths provide an AVC feature, these features are differentiated from each other in the figures and accompanying text by the addition of a send (S) or receive (R) prefix to the term AVC), AEC 845 and Noise Reduction 850; while a send path includes adaptive filter 710 (itself containing adaptation register 814 and summer 812) and voice enhancement features (S-VE) 715, the latter containing NLP 815, S-AVC 820 and Noise Compensation 825. Rₒᵤₜ pad 835 provides 6 db of attenuation, thus allowing the echo canceller to provide an enhanced hybrid return loss margin on a mobile-to-PSTN call. Since all these features and their implementational aspects are conventional and well-known in the art, I will omit any further details about them.

To allow inter-working of VEO and DSR with TFO through an echo canceller, inventive echo canceller 700 contains both message detectors 730 and 770 on incoming lines Sᵢₙ and Rᵢₙ, respectively, and message generators 720 and 790 on outgoing lines Sₒᵤₜ and Rₒᵤₜ, respectively. Each of these detectors determines the existence of an incoming IS (in-band signaling) message, carried through 2-bit robbed-bit signaling (as will be discussed in detail below in the context of FIG. 6), and routes that message, via a two-bit TFO bypass path, to its associated message generator. In particular, message detector 730 detects incoming TFO messages on Sᵢₙ line 705 and routes those messages, via two-bit TFO Bypass path 835, across send path voice enhancement stages, to message generator 720 which, in turn and for a TFO equipped BSC connected thereto, inserts those messages, using 2-bit robbed-bit signaling, back into the PCM sample stream applied to Sₒᵤₜ line 725. Message detector 770, in the receive path, detects incoming TFO messages on Rᵢₙ line 780 and routes those messages, via two-bit TFO Bypass path 860, across receive path voice enhancement stages, to message generator 790 which, in turn and for a TFO equipped BSC connected thereto, inserts those messages, using 2-bit robbed-bit signaling, back into the PCM sample stream applied to Rₒᵤₜ line 795.

Based on the existence/non-existence of such incoming TFO messages, and the specific TFO message then appearing, each echo canceller, through its internal control logic (logic 760, as will be described below in conjunction with FIG. 7) will automatically set its feature set accordingly based on the call type (mobile-to-mobile or mobile-to-PSTN) and, generate an appropriate IS message (again using 2-bit robbed-bit signaling) or not to its peer, i.e., distant, echo canceller situated at an opposite end of a call path. In that regard, the control logic, based on IS messages then appearing or not on Sᵢₙ line 705, will either enable or disable, as appropriate, AF 710 and, in a send (S) path, any of send-side voice enhancement (S-VE) features 715. Similarly, the control logic based on TFO messages then appearing or not on Rᵢₙ line 780, will either enable or disable, as appropriate, any receive-side voice enhancement (R-VE) features 785.

Hence and advantageously, each of the inventive echo cancellers 700_{A} and 700_{B}, situated at an opposite end of a call path, can inter-work and communicate with the other, across an MSC (or other intermediate switching centers—all not shown), and, based on messages which are received from the other and on a coordinated basis, enable individual voice enhancement (VE) and AF features which each canceller provides that are appropriate to the call, regardless of whether each BSC implements TFO or not.

This communication is advantageously accomplished, in accordance with the inventive teachings, by each echo canceller generating a unique message, i.e., one which has meaning only to its peer echo canceller.

With respect to the network configuration shown in FIG. 2, assume that neither BSC 220_{A} nor BSC 220_{B} (which correspond to BSCs 120_{A} and 120_{B} shown in FIG. 1) has TFO capability.

In this scenario, when each of echo cancellers 700_{A} and 700_{B}, and specifically message detectors 730 and 770 therein, detect an incoming IS_VT signal from the MSC and hence emanating from (and generated by) the other (distant) canceller but no TFO messages at all provided by the BSCs, both of these echo cancellers dynamically select a feature set as shown in FIG. 8 (also referred to as “Case 1”).

Note that an IS_VT message is a unique TFO message—not part of normal TFO call handling. The IS_VT message has meaning only with and is only interpreted by each canceller. Illustratively, this message is a digital inverse of an IS_REQ message. I have devised and implemented the IS_VT message not only to ensure TFO compatibility (i.e., carried through two-bit robbed-bit signaling) but also and advantageously to provide inter-canceller communication through which the cancellers can jointly communicate call type with each other and coordinate their operation. Clearly, other unique IS messages that may or may not be TFO compatible, but not used by BSCs, could be used in lieu of the IS_VT message.

In this instance and with respect to each canceller, as a result of message detector 730 detecting an IS_VT message incoming on Sᵢₙ line 705 in the send path and emanating from its peer echo canceller (e.g., 700_{B} for canceller 700_{A} and vice versa) and message detector 770 not detecting any TFO message emanating from its local BSC, the control logic in that canceller enables those features appropriate for a mobile-to-mobile call in a non-TFO environment: DSR 830, R-AVC 840, AEC 845 and Noise Reduction 850. No enhancements are enabled in the S path. Since neither BSC implements TFO, then the control logic disables two-bit TFO bypass 835 and 860. In this case, the control logic within the canceller instructs message generator 720 to produce no TFO messages on Sₒᵤₜ line 725 for transport to the local BSC and message generator 790 to produce IS_VT messages for transport through MSC 140 to its peer canceller. In this configuration, both cancellers are providing acoustic echo control, one instance of automatic volume control and noise reduction. Since adaptive filter 710 is disabled, then Rₒᵤₜ pad 835 is also disabled.

Now, consider a mobile-to-PSTN call. FIG. 3 depicts network configuration 300 for handling this type of call where a local BSC is not TFO equipped. The signal path of this call is from handset 105 through BSC 220_{A}, EC 700_{A}, MSC 140, trunks 143 to the PSTN and finally through distant hybrid (H) 310 and, via lines 320, to wireline telephone 330 (and vice versa). Given the high degree of commonality among FIGS. 2-5 and among FIG. 8-10, for the sake of brevity, the following discussions will only address the salient differences amongst each set of figures.

Here, while both BSC 220_{A} and EC 700_{A} operate the same as those shown in FIG. 2, there is no TFO or IS_VT message provided by this BSC or returned to this canceller. Accordingly and in response to the absence of message detectors 730 or 770 detecting any TFO or IS_VT message, canceller 700_{A}, specifically its internal control logic, will dynamically select a feature set, as shown in FIG. 9, (also referred to as “Case 2”) appropriate for a mobile-to-PSTN call. Since the BSC is not TFO equipped and hence does not generate IS messages, the control logic will instruct message generator 790 to continually generate IS_VT messages on Rₒᵤₜ line 795 for carriage through the MSC to its peer canceller. In this instance, and as shown in FIG. 9, all enhancements, with exception of DSR 830, are enabled. But since the BSC does not send any IS messages, two-bit TFO bypass paths 835 and 860 are also disabled.

At this point, consider the scenario depicted in FIGS. 4 and 9 for handling a mobile-to-mobile call through two BSCs 420_{A} and 420_{B} that are both TFO equipped.

Here, the calling BSC, such as BSC 420_{A}, generates an IS_REQ message which appears on Rᵢₙ line 780 of canceller 700_{A}. Message detector 770 detects this message and so informs the control logic within the canceller. The control logic then enables two-bit TFO bypass path 860 such that message generator 790 produces the same message, via 2-bit robbed-bit signaling, on Rₒᵤₜ line 795. Once this message reaches the distant echo canceller (700_{B}) on its Sᵢₙ line, that canceller similarly routes the message through to its associated BSC, i.e., BSC 420_{B}. In turn, that BSC, knowing that it is serving a mobile endpoint, generates an IS Acknowledge (IS_ACK) message. This acknowledge message appears on Rᵢₙ line 780 of the distant echo canceller (700_{B}). Similarly, once that message is detected by message detector 770 therein, it is routed under instruction of the internal control logic within that canceller, via two-bit TFO bypass path 860 to message generator 790 which, in turn, imparts that message, using 2-bit robbed-bit signaling, into an outgoing PCM stream appearing on Rₒᵤₜ line 795. That message is then carried through MSC 140 to Sᵢₙ line 705 of canceller 700_{A}. This message is then detected in this canceller by message detector 730. In response, the control logic in this canceller enables two-bit TFO bypass path 835 such that this message is applied to message generator 720 and, as a result, imparted into the PCM stream supplied by that canceller to BSC 420_{A}. Hence, receipt of this message confirms to that BSC that the remote endpoint of the call is a mobile device. As one can appreciate, the TFO IS_REQ and IS_ACK messages work properly when passing through both of the inventive echo cancellers. In this scenario, each of the cancellers will dynamically select a feature set, as shown in FIG. 10, (also referred to as “Case 3”) appropriate for a mobile-to-mobile call carried in a TFO environment. Specifically, each canceller will enable its AF and all its voice enhancement features, as well as both of its two-bit bypass paths. FIG. 10 depicts the specific TFO messages associated with EC 700_{A}; for EC 700_{B}, the IS_REQ and IS_ACK messages will simply be reversed from that shown in FIG. 10, in terms of the lines on which they appear. With TFO enabled on cancellers EC 700_{A} and EC 700_{B}, the two LSBs carry the 16 kilobit compressed voice and, as a backup, the upper six bits carry the normal μ- or A-law encoded speech as a backup.

With the above in mind, let us consider a scenario, as depicted in FIG. 5, in which a mobile-to-mobile call is being handled through network configuration 500 in which one BSC, i.e., BSC 420_{A}, is TFO equipped, but the other BSC, i.e., BSC 220_{B}, is not. As shown, BSC 420_{A} is sending IS_REQ messages and, as a result, forcing EC 700_{A} to do the same. The IS_REQ messages are passed through MSC 140, and EC 220_{B} to BSC 220_{B}. Since BSC 220_{B} is not TFO equipped, it will not send back any IS_ACK message (as contrasted with that shown in FIG. 4). Accordingly, canceller 700_{B} will send an IS_VT message. This message, in turn, is detected by EC 700_{A}. Since this message is not an IS_ACK message, canceller 700_{A} will not generate any message for BSC 420_{A}. Consequently, the call operates in a non-TFO mode with echo canceller 700_{A} dynamically setting its feature set to that shown in Case 1 (FIG. 8). Canceller 700_{B} will set its feature set to that shown in Case 2 (FIG. 9). As such, a caller using handset 105 will experience voice quality currently associated with conventional mobile-to-mobile calls while a caller using handset 175 will experience enhanced quality.

FIG. 6 depicts the two-bit robbed-bit signaling scheme discussed above and used by base station controllers (BSCs), and the inventive echo canceller, to carry TFO in-band signaling (IS) messages.

Specifically, a 1.544 MBit T1 or 2.048 MBit E1 (European) transmission format consists of 24 or 32 channels/timeslots, respectively. An analog signal for each channel is encoded into an 8-bit PCM (pulse code modulated) sample and is encoded at an 8 KHz clock rate resulting in a 64 KBit channel. Multiplexing the 24 or 32 channels together produces the T1 or E1 format. Once this T1 or E1 format is produced, two least significant bits (LSBs) of every N PCM samples, N being 16 here, of each channel are used to signal a presence or absence of a compatible echo canceller remotely located in the network. Specifically, the two LSBs of every 16^{th} PCM sample are used to indicate if the call will be mobile-to-mobile (as in FIG. 4) or mobile-to-PSTN (as in FIG. 3) by conveying bits that form the IS_VT message, or not. As depicted, each pair of robbed bits occurring over 16 samples is mapped, specifically successively appended to other such bits, into an entire 12-bit IS message, with this process then repeating itself to form a next successive IS message, and so forth. Illustratively, consider IS message 610 (IS_REQ, IS_ACK or IS_VT) which occurs over 96 successive PCM samples 620, which are formed of individual samples 6201, 6202, . . . The two LSBs of samples 620₁, 620₁₇ and 620₃₃ are themselves copied and appended together, as represented by lines 625, 630 and 635 to form the first six bits (e.g., 000100) in the IS message, here an IS_VT message (0×129 hex), and so forth for the remaining samples from which bits are robbed. Once IS message 610 has been received, the process repeats itself for next successive IS message 640 carried by PCM samples 650, these samples containing individual samples 650₁, 650₂. . .

Alternatively, the number of bits that are robbed could be one instead of two and the number of PCM samples between the samples containing the robbed bits could be different than sixteen used herein. However, to utilize the inventive inter-canceller communication for coordinating operation of two cancellers situated on opposite ends of a call, bit patterns must be those that are able to exist in cellular network configuration mainly in Europe and which utilize TFO, as shown in FIGS. 4 and 5. As discussed above, mobile-to-mobile calls that utilize TFO can also benefit from the use of the present invention where one of the BSCs that serves one of the endpoints is not TFO equipped. Furthermore, to permit the inventive cancellers, with their coordinated selection of voice enhancement features, to co-exist in the same cellular network, the IS_VT message should be the same as a routine background message in the TFO format. There are many TFO messages but there are only two that are critical to the proper operation of an echo canceller in a TFO equipped network. These messages are the IS_REQ and IS_ACK (request and acknowledge) messages. A third message, the IS_FILL message is continually sent in background on any TFO equipped trunk but that message is not part of normal TFO call handling. For maximum network compatibility with TFO equipped BSCs, the inventive canceller simply reuses the IS_FILL message as the IS_VT message. The IS_FILL message, being a fill message, is just ignored by TFO equipped BSCs during normal call handling and thus this message provides sufficient uniqueness, at those instances when it is used, for inter-canceller communication. Table 1 below provides hexadecimal values for the three commands that TFO utilizes; the IS_FILL message is identical to the IS_VT message.

TABLE 1

| Command | Hexadecimal code | Description |
|---|---|---|
| IS_REQ | 0x05D | TFO Request |
| | | Message |
| IS_ACK | 0x0BA | TFO Acknowledge |
| | | Message |
| IS_FILL or IS_VT | 0x129 | TFO Fill Message |
| | | or |
| | | unique EC |
| | | Signaling Message, |
| | | respectively |

Lastly, FIG. 7 depicts a high-level block diagram of message detection/generation (communication) and control sections of the inventive echo canceller 700.

As shown, canceller 700 contains adaptive filtering stage 710, send voice enhancement (S-VE) features 715; receive voice enhancement (R-VE) features 785; message detectors 730 and 770; gates 740, 741, 744, 745 and 750; control logic 760; and message generators 720 and 790.

In essence, message detectors 730 and 770 detect whether any of three different IS messages, or no such messages, then appear on Sᵢₙ and Rᵢₙ lines 705 and 780, respectively. Based on which messages, and/or the absence of any such messages, then concurrently appear on both of these lines, a control signal is provided on one of three inputs corresponding to Case 1, Case 2 and Case 3, to control logic 760. In response, the control logic: (a) sets AF 710, S-VE 715 and R-VE 785 to dynamically enable the proper enhancements for the particular call then being handled, and (b) also instructs message generators 720 and 790 to generate appropriate TFO messages for application to Sₒᵤₜ and Rₒᵤₜ lines 725 and 795, respectively.

Specifically, if message detector 730 detects an incoming IS-VT message on Sᵢₙ line 705, it generates a high level on line 734 which is routed through gate 740, which serves as a buffer, to input line 742 to control logic 760 thus instructing the control logic to set the enhancements for Case 1 (non-TFO mobile-to-mobile call). Alternatively, if message detector 730 detects no incoming TFO message on Sᵢₙ line 705, it generates a high level on line 732 which is routed through gate 745, which also serves as a buffer, and OR gate 744 to input line 746 to control logic 760 thus instructing the control logic to set the enhancements for Case 2 (mobile-to-PSTN call). Further, if message detector 730 and 770 both detect incoming IS_REQ or IS_ACK messages on Sᵢₙ and Rᵢₙ lines 705 and 780, these detectors apply a high level to leads 736 and 776. These levels are logically combined by AND gate 750 which, in turn, generates a high level on input lead 752 to the control logic to instruct the control logic to set the enhancements for Case 3 ( TFO and mobile-to-mobile call where both cancellers will set themselves to provide two-bit TFO bypass in both directions using TFO bypasses 835 and 860 and six bit μ- or A-law processing). For a mixed TFO and non-TFO BSC mobile-to-mobile call, IS_REQ at lead 736 is high and simultaneously the No Msg at lead 772 is also high. High on these two leads causes gate 741 to output a high level on lead 743. This lead is connected as one input to OR gate 744. A high level in put at OR gate 744 results in a high level on output lead 746, thus selecting Case 2. Given the control levels appearing on leads 742, 746 and 752, control logic 760 then instructs, via leads 762 and 7.66, AF 710 and S-VE 715 and R-VE 785 to enable the appropriate features (as discussed above in conjunction with FIGS. 8-10). In addition, control logic 760 instructs, via leads 764 and 768, message generator 720 and 790 to generate appropriate IS messages. For cases 1 and 2, message generator 720 will produce an IS_VT message and message generator 790 will produce no message. For case 3, the generators will produce an IS_VT or no message until either an IS_REQ or IS_ACK message is detected on either Sᵢₙ line 705 or Rᵢₙ line 780 at which point the IS_VT message will be replaced on the Sₒᵤₜ line 725 by the IS_REQ message or an IS_ACK message will appear on Rₒᵤₜ line 795, respectively, for TFO use.

While I have described the inventive echo canceller in the context of communicating with its peer canceller, through in-band signaling and particularly use of a unique IS message, to enable both cancellers to set particular enhancement feature sets based on call type and TFO/non-TFO operation of associated BSCs through which the call transits, clearly such communication can be used to pass other information between the cancellers and, where appropriate, customize the operation of either or both of the cancellers to a specific situation. This information could include, e.g., status and self-test information for diagnostic, monitoring and management functions, or commands to dynamically set operating parameters of any of the voice enhancement features of a remote echo canceller, and hence intentionally vary its performance, by entry at or detection by a local canceller. For example, if one echo canceller were to detect a change in voice quality at its end of a call which, to provide optimum quality to both endpoints of that call, necessitates changes in operational characteristics at both cancellers, or even in just one particular enhancement feature, or just at its peer canceller, each canceller could-instruct each other as to which changes are necessary at the latter and, through coordinated operation, invoke those changes. Alternatively, if one canceller just needs to change its own operating characteristics of any given feature(s), it could simply inform its peer canceller of those changes such that both cancellers remain fully aware of those specific features and their characteristics that each is then providing to a given call such that both cancellers maintain coordinated operation.

Moreover, while I have described two of the inventive echo cancellers (e.g., EC 700_{A} and 700_{B}), as inter-communicating with each other through a single specific signaling message (here being the IS_VT message) transiting between both cancellers, this communication could occur at times just on a one-sided basis, i.e., with an appropriate message just flowing from one canceller to the other but not in reverse. Such one-sided communication may be appropriate for, e.g., monitoring/reporting applications where the one canceller merely passes its status information to the other. Furthermore, rather than using a single unique signaling message, each canceller can utilize a different such message in communicating with its peer, and both cancellers can utilize a multitude of such messages based on the intended functions of each such message.

While I have described the present invention in the context of use with mobile (e.g., cellular) calls, -the ability to coordinate inter-canceller operation, through unique inter-canceller communication, is likely to be rather useful across a wide variety of echo canceller applications.

Further, while use of TFO messaging is rather convenient, unique in-band inter-canceller communication need not be limited to TFO messages and can be implemented totally independently of TFO messaging as well as through a different messaging format from TFO.

Although a single embodiment which incorporates the teachings of the present invention has been shown and described in considerable detail herein, those skilled in the art can readily devise many other embodiments and applications of the present invention that still utilize these teachings.

I claim:

1. Apparatus for a first echo canceller which is adapted to be located on one end of a call path and which substantially cancels echo that would otherwise appear on said path, the first echo canceller comprising:
communication circuitry having a first message detector, the first message detector operative to detect a first signaling message originating at a second echo canceller situated on an opposite end of the call path from the first echo canceller; and
control circuitry, responsive to the first message detector, for invoking an associated operation by the first echo canceller as a result of the first signaling message such that the first and second echo cancellers can interact together as required by the first signaling message.

2. The apparatus in claim 1 wherein the communication circuitry further comprises a first message generator; and the control circuitry generates, through the first message generator, a second signaling message for carriage to the second echo canceller such that the first and second echo cancellers can interact together and coordinate their operation with each other as required by the first and second signaling messages.

3. The apparatus in claim 2 wherein the first and second signaling messages are in-band messages appearing over the call path.

4. The apparatus in claim 3 wherein the in-band messages are tandem free operation (TFO) messages that are implemented through robbed-bit signaling of separate pulse coded modulated (PCM) voice samples in a PCM voice stream applied to the first and second echo cancellers.

5. The apparatus in claim 4 wherein the first and second signaling messages comprise a common TFO signaling message.

6. The apparatus of claim 5 wherein the robbed-bit signaling utilizes two least significant bits of every 16th occurring PCM sample in the voice stream.

7. The apparatus in claim 2 wherein the communication circuitry further comprises a second message detector for detecting a signaling message generated by telephony equipment located on the same end of the call path as the first echo canceller and a second message generator for generating a signaling message to said telephony equipment and wherein the control circuitry, responsive to both the first and second message detectors, changes the operation of the first echo canceller and generates, through the second message generator, the signaling message to the equipment.

8. The apparatus in claim 7 wherein the first echo canceller further comprises individually selectable voice enhancement features, each of which can be imparted to a stream of voice samples incoming to the first echo canceller; and the control circuitry enables individual ones of the voice enhancement features to be applied to said stream in response to both the first signaling message and the signaling message detected by the second message detector.

9. The apparatus in claim 8 wherein the equipment comprises a base station controller, and the first and second signaling messages convey information regarding a type of call to be handled by the first and second echo cancellers.

10. The apparatus in claim 9 wherein the type of call comprises either a mobile-to-mobile or mobile-to-PSTN (public switched telephone network) call.

11. The apparatus in claim 10 wherein all the signaling messages are in-band messages appearing over the call path.

12. The apparatus in claim 11 wherein the in-band messages are tandem free operation (TFO) messages that are implemented through robbed-bit signaling of separate pulse coded modulated (PCM) voice samples in a PCM voice stream applied to the first and second echo cancellers.

13. The apparatus in claim 12 wherein the first and second signaling messages are a specific TFO signaling message.

14. The apparatus of claim 13 wherein the robbed-bit signaling utilizes two least significant bits of every 16th occurring PCM sample in the voice stream.

15. The apparatus in claim 14 wherein the specific TFO signaling message comprises an IS_FILL message.

16. A method for use in a first echo canceller which is adapted to be located on one end of a call path and which substantially cancels echo that would otherwise appear on said path, the method comprising the steps of:
first detecting a first signaling message originating at a second echo canceller situated on an opposite end of the call path from the first echo canceller so as to define a detected first message; and
invoking, in response to the detected first message, an associated operation by the first echo canceller as a result of the first signaling message such that the first and second echo cancellers can interact together as required by the first signaling message.

17. The method in claim 16 further comprising the step of first generating a second signaling message for carriage to the second echo canceller such that the first and second echo cancellers can interact together and coordinate their operation with each other as required by the first and second signaling messages.

18. The method in claim 17 wherein the first and second signaling messages are in-band messages appearing over the call path.

19. The method in claim 18 wherein the in-band messages are tandem free operation (TFO) messages that are implemented through robbed-bit signaling of separate pulse coded modulated (PCM) voice samples in a PCM voice stream applied to the first and second echo cancellers.

20. The method in claim 19 wherein the first and second signaling messages comprise a common TFO signaling message.

21. The method in claim 17 further comprising the steps of:
detecting a signaling message generated by telephony equipment located on the same end of the call path as the first echo canceller; and
in response to both the first and second message detecting steps, changing the operation of the first echo canceller and generating a signaling message to the equipment.

22. The method in claim 21 wherein the first echo canceller further comprises individually selectable voice enhancement features, each of which can be imparted to a stream of voice samples incoming to the first echo canceller; the method further comprising the step of enabling individual ones of the voice enhancement features to be applied to said stream in response to both the first signaling message and the signaling message detected by the second message detecting step.

23. The method in claim 22 wherein the first and second signaling messages convey information regarding a type of call to be handled by the first and second echo cancellers.

24. The method in claim 23 wherein the type of call comprises either a mobile-to-mobile or mobile-to-PSTN (public switched telephone network) call.

25. The method in claim 24 wherein all the signaling messages are in-band messages appearing over the call path.

26. The method in claim 25 wherein the in-band messages are tandem free operation (TFO) messages that are implemented through robbed-bit signaling of separate pulse coded modulated (PCM) voice samples in a PCM voice stream applied to the first and second echo cancellers.

27. The method in claim 26 wherein the first and second signaling messages are a specific TFO signaling message.

28. The method in claim 27 wherein the specific TFO signaling message comprises an IS_FILL message.
